(19) United States
(12) Patent Application Publication
(10) Pub. No.: US 2006/0268334 A1
(43) Pub. Date: Nov. 30, 2006

(54) Data processing apparatus connectable to network, and control method therefor

(75) Inventor: Tadahiro Nakamura, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/432,440

(22) Filed: May 11, 2006

(30) Foreign Application Priority Data
May 17, 2005 (JP) 2005-143722

(51) Int. Cl. G06F 3/12

(52) U.S. Cl. 358/1.15; 358/448

(57) ABSTRACT

A data processing apparatus having an e-mail receiving function and a function for obtaining a resource on a network. An e-mail that includes access information for accessing the resource on the network is received. Then, the access information included in the received e-mail is extracted. The resource on the network is obtained in accordance with the extracted access information. Then, the obtained resource may be subjected to a printing operation.

### BACKGROUND OF THE INVENTION

1. Field of the Invention

The present invention relates to a data processing apparatus connectable to a network. More specifically, the present invention relates to a data processing apparatus capable of obtaining and processing data on a network and to a method of controlling the data processing apparatus.

2. Description of the Related Art

Recently, an apparatuses of this kind, such as a multifunction apparatus that is provided with various functions based on a digital copying machine, have been utilized. Such a multifunction apparatus is capable of performing tasks by using a scanner and a printer, for example, that are provided as features of the digital copying machine. That is, for example, the multifunction apparatus can send an image read through the scanner to a terminal device on a network or print an image distributed by a terminal device on the network by using the printer.

Further, with respect to a printing function, a secure print function may be implemented. In the secure print function, a user ID/password specified at the time of an instruction for printing by the user through the terminal device is input through an operation panel of the digital copying machine before printing is started.

In addition, recently a new function, namely, a personal box function, has been implemented. The personal box function is a function in which an area (personal box) that is segmented and associated with an individual user, or a specific group, division or the like, is provided to a storage device of the digital copying machine to store therein image data for printing and image data input through the scanner so as to output the image data at a desired timing.

In addition, recently, the sizes of the operation panels of digital copying machines have become larger and larger. In this regard, there have been made available operation panels which are capable of displaying the monitoring of an operation performed through a terminal device on a network and the state of the terminal device. And also, an operation panel has been made available that is capable of displaying web content by a browser function, as well as performing the operation for functions that utilize the scanner and the printer (see, for example, Japanese Patent Application Laid-Open No. 2002-200827).

The browser function that is provided to a digital copying machine is hereinafter referred to as an embedded browser. The digital copying machine can obtain web content on the network by using the embedded browser function and print the obtained web content by the printer. When the user obtains the content on the network by using the embedded browser, the user needs to directly operate the operation panel of the digital copying machine or to use application software for a remote operation of the digital copying machine through a terminal device on the network.

In addition, in the former case, namely, in directly operating the operation panel of the digital copying machine, the operation is too complicated. Moreover, in the latter case, namely in remotely operating the digital copying machine through a terminal device on the network, it is necessary to operate special application software on the terminal device. Further, the user needs to move back and forward again and again between the terminal device and the digital copying machine.

Meanwhile, in other data processing apparatuses such as a mobile terminal device, personal digital assistance (PDA) or a cellular phone, e-mail functions equivalent to that of a personal computer are also provided as features of these devices. Thus, e-mail text can readily be produced and the produced e-mail can be sent to a desired destination.

However, in such a mobile terminal device, in browsing web content, some of the content may be restricted for browsing, and an operation to be performed by the user in this case is typically too complicated.

### SUMMARY OF THE INVENTION

The present invention provides a data processing apparatus and a control method therefor which overcome the aforementioned inconveniences and drawbacks. Additionally, the data processing apparatus is capable of obtaining and processing content based on a received e-mail in accordance with descriptions of the e-mail. Furthermore, the data processing apparatus is capable of readily obtaining and processing desired content without using application software dedicated to the data processing apparatus.

According to one exemplary embodiment of the present invention, a data processing apparatus is provided which includes a receiving unit configured to receive an electronic mail including access information for accessing resource from a network; an extracting unit configured to extract the access information from the received electronic mail; an obtaining unit configured to obtain resource from the network based on the extracted access information; and a processor configured to process the obtained resource in accordance with a predetermined procedure.

According to an aspect of the present embodiment, the apparatus further includes a printer adapted to print an image, wherein the processor supplies the obtained resource to the printer and causes the printer to print an image based on the resource. According to another aspect of the present embodiment, the receiving unit receives the electronic mail including the access information and a printing parameter, and the printer prints the image based on the printing parameter.

According to yet another aspect of the present embodiment, the receiving unit receives the electronic mail including the access information and password for instructing the printer to start the printing, and the printer starts printing in response to entering the password. Moreover, according to another aspect of the present embodiment the apparatus further includes a storage unit configured to store the obtained resource, wherein the processor supplies the obtained resource to the storage unit and causes the storage unit to store the resource.

Furthermore, according to another aspect of the present embodiment the processor changes the processing in accordance with a source of the received electronic mail. Moreover, according to another aspect of the present embodiment, the processor changes the processing in accordance with a destination address of the received electronic mail.

According to one exemplary embodiment of the present invention, a control method is provided for a data processing apparatus which includes receiving an electronic mail including access information for accessing resource on a network; extracting the access information from the received electronic mail; obtaining the resource from the network based on the extracted access information; and processing the obtained resource in accordance with a predetermined procedure.

Still further, according to yet one exemplary embodiment of the present invention, a computer readable medium is provided which contains computer-executable instructions for controlling a data processing apparatus. The medium includes instructions to receive an electronic mail including access information for accessing resource from a network; instructions to extract the received access information from the received electronic mail; instructions to obtain the resource from the network based on the extracted access information; and instructions to process the obtained resource in accordance with a predetermined procedure.

Furthermore, numerous other features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous embodiments, features and aspects of the present invention and, together with the description, serve to explain the principles of the invention.

FIG. 1 is a diagram illustrating an example of a network system to which a data processing apparatus according to a first embodiment of the present invention can be applied.

FIG. 2 is a block diagram illustrating an exemplary configuration of a copying machine shown in FIG. 1.

FIG. 3 is a diagram illustrating an exemplary hardware configuration of a reader unit and a printer unit of the copying machine shown in FIG. 1.

FIG. 4 is a plan view illustrating an exemplary configuration of an operation unit shown in FIG. 2.

FIG. 5 is a diagram illustrating an exemplary operation screen displayed by an LCD display unit of the operation unit shown in FIG. 4.

FIG. 6 is a diagram illustrating an exemplary operation screen displayed by the LCD display unit of the operation unit shown in FIG. 4.

FIG. 7 is a diagram illustrating an exemplary method of logically using a hard disk drive (HDD) shown in FIG. 2.

FIG. 8 is a diagram illustrating an exemplary application software configuration executed by a CPU shown in FIG. 2.

FIG. 9 is a diagram illustrating an example of an e-mail transmitted from a client computer to the copying machine shown in FIG. 1.

FIG. 10 is a flow chart illustrating an example of a first data processing procedure in the copying machine according to the first embodiment.

FIG. 11 is a flow chart illustrating an example of a second data processing procedure in the copying machine according to the first embodiment.

FIG. 12 is a diagram illustrating an example of a dialog displayed by the LCD display unit of the operation unit shown in FIG. 4.

FIG. 13 is a diagram illustrating an example of a print setting screen displayed by the LCD display unit of the operation unit shown in FIG. 4.

FIG. 14 is a diagram illustrating an example of a print instruction mail according to a second embodiment of the present invention.

FIG. 15 is a diagram illustrating an example of a print instruction mail according to a third embodiment of the present invention.

FIG. 16 is a diagram illustrating an example of a storage instruction mail according to a fourth embodiment of the present invention.

FIG. 17 is a flow chart illustrating an example of a second data processing procedure in the copying machine according to the fourth embodiment of the present invention.

FIG. 18 is a diagram illustrating an example of a print instruction mail according to a fifth embodiment of the present invention.

FIG. 19 is a diagram illustrating an example of a dialog for a secure print instruction screen displayed in a copying machine according to the fifth embodiment of the present invention.

FIG. 20 is a diagram illustrating an exemplary memory map of a storage medium for storing various kinds of data processing programs that can be read by the copying machine according to the embodiments of the present invention.

### DETAILED DESCRIPTION OF THE EMBODIMENTS

Numerous exemplary embodiments, features and aspects of the present invention will now be herein described in detail with reference to the drawings. It should be noted that the relative arrangement of the components, the numerical expressions and numerical values set forth in these embodiments are not intended to limit the scope of the present invention unless it is specifically stated otherwise.

### First Exemplary Embodiment

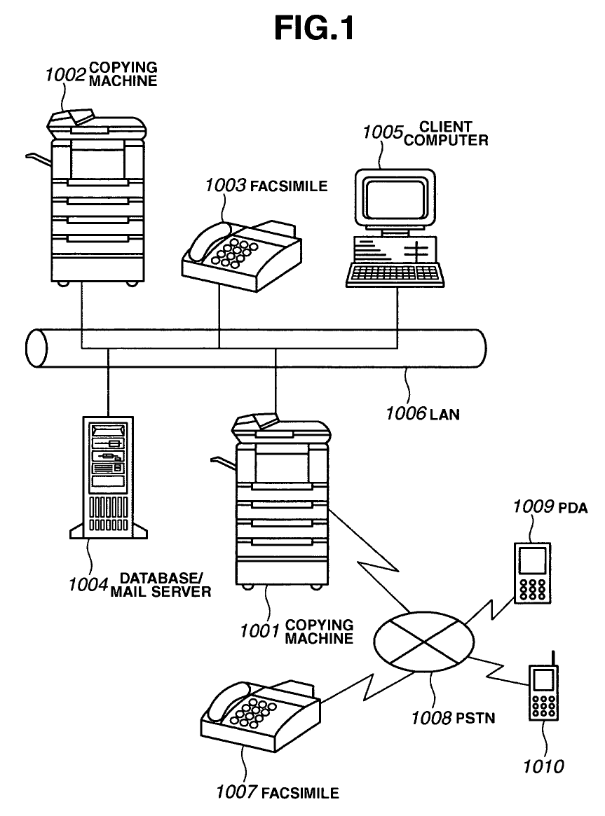

FIG. 1 is a diagram illustrating an example of a network system to which an image processing apparatus according to a first embodiment of the present invention can be applied. In this embodiment, a case is explained where a digital copying machine 1001 is utilized as an example of the image processing apparatus. However, the image processing apparatus is not limited to the digital copying machine, and various other kinds of apparatuses can be applied, as long as the apparatus is provided with a system that is capable of connecting to a network and obtaining content on the network and various information to perform a processing such as printing (including storing, displaying, sending, and the like).

In addition, the digital copying machine 1001 can mutually communicate with a client computer, a portable device (e.g., a personal digital assistance (PDA) or a cellular phone), and the like, that are external devices on the network, via a predetermined communication medium. In addition, the image processing apparatus is provided with a communication function using a given protocol such as SMTP, POP3, and the like so as to send and receive an e-mail.

In FIG. 1, the copying machine 1001, a copying machine 1002 that has a similar function as the copying machine 1001, a facsimile 1003, a database/mail server 1004, a client computer 1005, an Ethernet (registered trademark) (product name), and the like are connected to a local area network (LAN) 1006.

Further, the copying machine 1001 can communicate with a facsimile 1007 via a public switched telephone network (PSTN) 1008. The copying machine 1001 is provided with a copying function and a facsimile function, and is also provided with a data transmission function for reading an original image and transmitting the read original image to each device on the LAN 1006.

In addition, the copying machine 1001 has a page description language (PDL) interpretation function and thus is capable of receiving and printing PDL data instructed by the client computer 1005 connected to the LAN 1006.

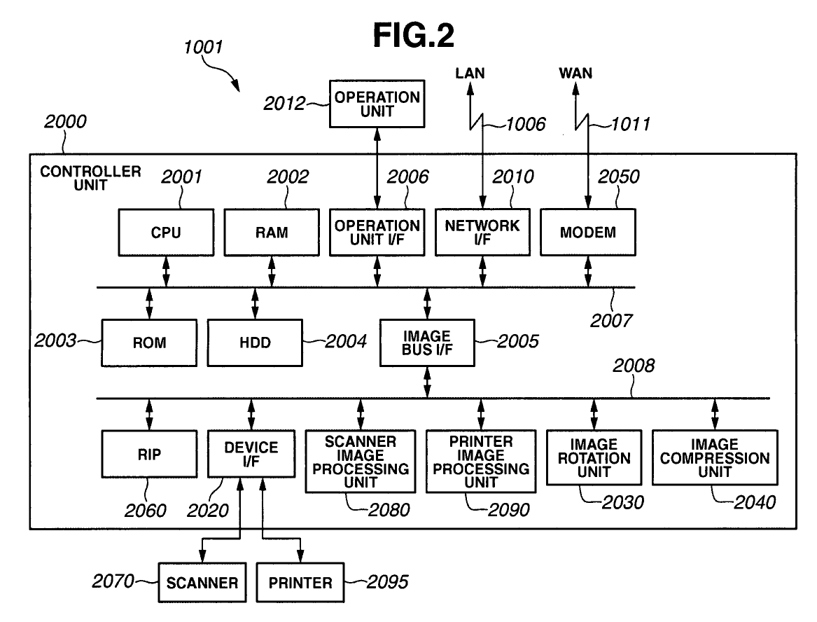

In addition, the copying machine 1001 is capable of storing image data obtained by reading an original by using the scanner function and PDL data received from the client computer 1005 on the LAN 1006 into a specified box area of a hard disk drive (HDD) 2004 shown in FIG. 2. In addition, the copying machine 1001 can print image data stored in the box area by using the printer function of the copying machine 1001.

The copying machine 1001 can receive via the LAN 1006 data read by the copying machine 1002 using the scanner function, store the received data into the hard disk drive 2004 (see FIG. 2) in the copying machine 1001, and print out the data using the printer function. In addition, the copying machine 1001 can receive image data from the client computer 1005 or the database/mail server 1004 via the LAN 1006, store the image data into the hard disk drive 2004 in the copying machine 1001, and also print out the image data using the printer function.

The facsimile 1003 can receive data read by the copying machine 1001 using the scanner function via the LAN 1006 and transmit the received data via the LAN 1006.

The database/mail server 1004 is provided with a function for receiving the data read by the copying machine 1001 by using the scanner function via the LAN 1006 and storing the received data into a database. In addition, the database/mail server 1004 functions and operates as a publicly known e-mail server (an SMTP server or a POP3 server). The database/mail server 1004 sends the e-mail received from the copying machine 1001 to a sending destination e-mail address that is described in a header portion. The database/mail server 1004 also transfers the e-mail whose specified sending destination is the copying machine 1001 to the copying machine 1001. The copying machine 1001, after receiving the e-mail, prints out the received e-mail by using the printer function and stores the received e-mail into the hard disk drive 2004.

The client computer 1005 can obtain desired data from the database/mail server 1004 and visually display the obtained data on a display. In addition, the client computer 1005 can receive the data read by the copying machine 1001 by using the scanner function via the LAN 1006 and process and edit the received data. The facsimile 1007 can receive the data read by the copying machine 1001 by using the scanner function via the PSTN 1008 and print out the received data.

A personal digital assistance (PDA) 1009 is a portable device that is provided with an e-mail sending/receiving function, a web browser function, and the like. The PDA 1009 is installed with a display device and a connection terminal for connecting to external devices. The PDA 1009 operates by a general-purpose battery and by a dedicated battery. Reference numeral 1010 denotes a cellular phone that is provided with a function as a telephone, an e-mail sending/receiving function, a web browser function, and the like. The cellular phone 1010 can transfer a moving image as well as a still image.

In addition, the PDA 1009 can perform various kinds of processings by causing a controller installed in the PDA 1009 to execute various kinds of control programs stored in a ROM and the like, based on an instruction made by operating icons and the like displayed on the screen. In addition, the cellular phone 1010 also can perform various kinds of processings by causing a controller installed in the cellular phone 1010 to execute various kinds of control programs stored in a ROM and the like, based on an instruction made through operation buttons and the like. Note that the web browser function that the cellular phone 1010 and the like utilize differs with respect to the setting of the functions and the operation method, depending on service providers. However, with respect to the e-mail sending/receiving function, a system environment is an environment under which the e-mail can be sent and received between service providers without hindrance, in the embodiment of the present invention.

In the present embodiment, an e-mail can be sent from the PDA 1009 or the cellular phone 1010 to the copying machine 1001 or the copying machine 1002, with a URL and a print setting instruction or a URL and an instruction related to an image processing function being included in the e-mail. The instructions are intended to obtain content from a web-based environment such as the Internet and to issue an instruction for printing by a print device. In this regard, the portable device can function as a remote operation unit. Thus, in addition to a local operation through the operation panel (screen) of the copying machine 1001 or the copying machine 1002, various kinds of print processing settings can be performed by utilizing the portable device.

FIG. 2 is a block diagram illustrating an exemplary configuration of the copying machine 1001 shown in FIG. 1. A controller unit 2000 is provided with a CPU 2001. The CPU 2001 controls the copying machine 1001. The CPU 2001 activates an operating system (OS) by a boot program stored in a ROM 2003, executes an application program stored in the hard disk drive (HDD) 2004 on the OS, and thus performs various kinds of processings.

For a work area of the CPU 2001, a RAM 2002 is utilized. The RAM 2002 provides an image memory area for temporarily storing image data. The HDD 2004 stores the image data as well as the above application program. There are connected to the CPU 2001, via a system bus 2007, the ROM 2003, the RAM 2002, an operation unit interface (I/F) 2006, a network I/F 2010, a modem 2050, and an image bus I/F 2005.

The operation unit I/F 2006 is an interface with an operation unit 2012 having a touch panel, and outputs to the operation unit 2012 drawing data to be displayed by the operation unit 2012. In addition, the operation unit I/F 2006 sends information input by the user operating the operation unit 2012 to the CPU 2001.

The network I/F 2010 is connected to the LAN 1006 and communicates information with each device on the LAN 1006 via the LAN 1006. The modem 2050 is connected to a wide area network (WAN) 1011 and communicates information with each device on the LAN 1006 via the WAN 1011. The WAN 1011 is similar to the PSTN 1008.

The image bus I/F 2005 is a bus bridge for connecting the system bus 2007 and an image bus 2008 that transmits the image data at a high speed and for converting a data structure. The image bus 2008 includes a PCI bus or an IEEE 1394 bus. The image bus 2008 is provided thereon with a raster image processor (RIP) 2060, a device I/F 2020, a scanner image processing unit 2080, a printer mage processing unit 2090, an image rotation unit 2030, and an image compression unit 2040.

The RIP 2060 is a processor that rasterizes PDL (Page Description Language) code into a bitmap image. A scanner 2070 and a printer 2095 are connected to the device I/F 2020. The copying machine 1001 is provided with a copying function for outputting image data input through the scanner 2070 to the printer 2095, an image sending function for outputting image data input through the scanner 2070 via the LAN 1006, a print function for printing image data received via the LAN 1006 by the printer 2095, a facsimile function for sending and receiving facsimile data via the WAN 1011, and the like.

The scanner image processing unit 2080 corrects, processes, and edits image data input through the scanner 2070. The printer image processing unit 2090 corrects image data to be output to the printer 2095 and converts the resolution thereof. The image rotation unit 2030 rotates image data. The image compression unit 2040 compresses multilevel image data into JPEG data and binary image data into data such as JBIG, MMR, MH, and the like, and carries out decompression processing of the compressed data.

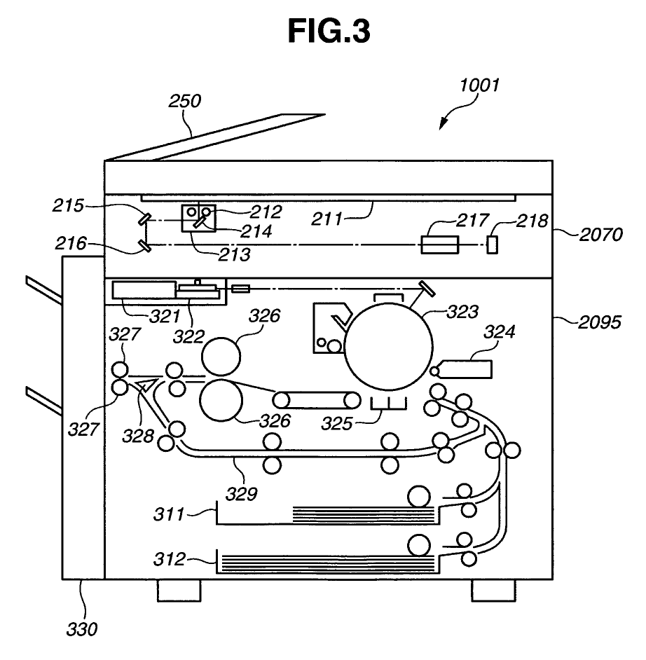

FIG. 3 is a diagram illustrating an exemplary hardware configuration of the scanner 2070 and the printer 2095 of the copying machine 1001 shown in FIG. 1 and FIG. 2. The scanner 2070 and the printer 2095 are integrally configured. The scanner 2070 is installed with an original feeding unit 250. The original feeding unit 250 feeds an original onto a platen glass 211 sheet by sheet in order from a top page and discharges the original from the platen glass 211 to a discharge tray (not shown) every time an operation for reading each of the sheets of the original is completed.

The scanner 2070 turns on a lamp 212 when the original is fed onto the platen glass 211 and then starts the movement of a moving unit 213. The original on the platen glass 211 is read and scanned by the movement of the moving unit 213. During reading and scanning, light reflected from the original is guided to a CCD image sensor (hereinafter referred to as a CCD) 218 via mirrors 214, 215, and 216 and a lens 217. Thus, an image on the original is formed on an imaging surface of the CCD 218. The CCD 218 converts the image formed on the imaging surface into an electric signal, and the converted electric signal is input to a controller 2000 after being subjected to a prescribed processing.

The printer 2095 is provided with a laser driver 321. The laser driver 321 drives a laser beam emitting unit 322 based on image data input from the controller unit 2000. Thereby, a laser beam in accordance with the image data is emitted from the laser beam emitting unit 322, and the laser beam is irradiated onto a photosensitive drum 323 while being scanned. An electrostatic latent image is formed on the photosensitive drum 323 by the irradiated laser beam, and the electrostatic latent image is visualized as a toner image by a toner supplied from a developing device 324. A recording paper sheet is fed from a cassette 311 or 312 via a conveyance path into a portion between the photosensitive drum 323 and a transfer unit 325. The toner image on the photosensitive drum 323 is transferred onto the recording paper sheet fed by the transfer unit 325.

The recording paper sheet onto which the toner image is transferred is fed to a pair of fixing rollers (a heating roller and a pressure roller) 326. The pair of fixing rollers 326 heats and presses the recording paper sheet and fixes the toner image on the recording paper sheet to the recording paper sheet. The recording paper sheet that passes the pair of fixing rollers 326 is discharged to a paper discharge unit 330 by a pair of discharge rollers 327. The paper discharge unit 330 is configured by a sheet processing device capable of carrying out a post-processing such as sorting, stapling, and the like. In addition, in a case where a two-sided recording mode is set, a direction of rotation of the pair of discharge rollers 327 is reversed after the recording paper sheet is conveyed to the pair of discharge rollers 327, and the recording paper sheet is guided to a re-feed conveyance path 329 by a flapper 328. The recording paper sheet guided to the re-feed conveyance path 329 is re-fed to the portion between the photosensitive drum 323 and the transfer unit 325 at the timing mentioned above, and a toner image is transferred on a back surface of the recording paper sheet.

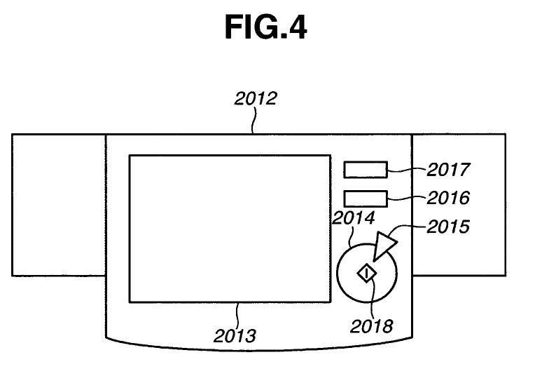

FIG. 4 shows an exemplary configuration of the operation unit 2012 shown in FIG. 2. An LCD display unit 2013 has a configuration such that a touch panel sheet is attached onto an LCD. The LCD display unit 2013 displays an operation screen of the system and, when a displayed key is pushed down, transmits positional information of the key to the CPU 2001 of the controller unit 2000. A start key 2014 is used to start the operation for reading the original image, and the like.

In a center portion of the start key 2014, there is provided a light-emitting diode (LED) 2018 of two colors of green and red. The color of the LED 2018 indicates whether the start key 2014 is in a usable state or not. A stop key 2015 is operated to stop the operation currently in operation. An ID key 2016 is used at the time of inputting a user ID of the user. A reset key 2017 is used to initialize the setting set by the operation unit 2012.

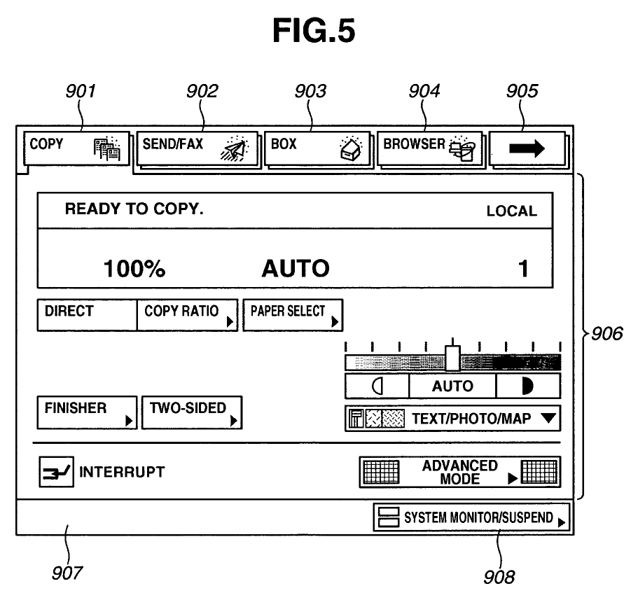

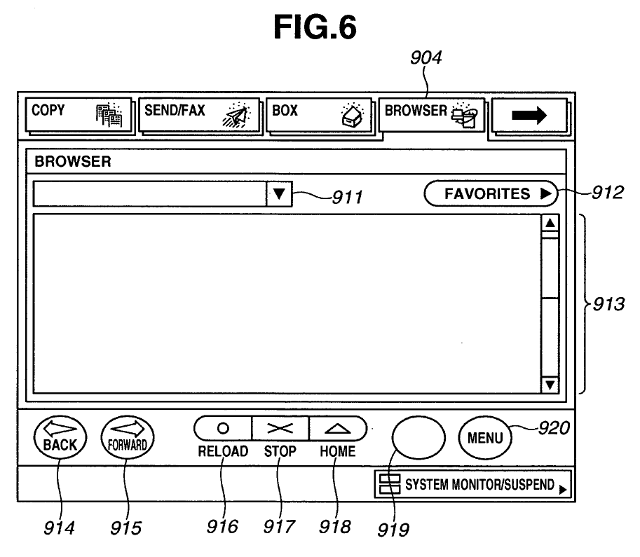

FIGS. 5 and 6 are diagrams illustrating exemplary operation screens displayed by the LCD display unit 2013 of the operation unit 2012 shown in FIG. 4. FIG. 5 illustrates a standard screen, and FIG. 6 illustrates a browser activation screen.

In FIG. 5, in an upper portion of the operation display of the operation unit 2012, touch keys such as a Copy tab 901, a Send/FAX tab 902, a Box tab 903, a Browser tab 904, each of which is displayed in the form of a tab per a plurality of functions, are displayed. In the HDD 2004 of the controller unit 2000, a program for displaying the web browser is incorporated, which enables the display of the web browser as shown in FIG. 6 in response to an instruction form the operation unit 2012.

Note that in a case where five or more functions are installed in the controller unit 2000, a Right Arrow key 905 is displayed to the right of the four function tabs of Copy, Send/Fax, Box, and Browser. When the Right Arrow key 905 is pushed down, a screen for other functions is displayed.

FIG. 5 shows an initial screen for the copying function when the touch key of the Copy tab 901 is pushed down. The display in relation to the copying function is carried out through a bracketed portion 906. In a portion in which the message of “Ready to Copy” is indicated, which is in the upper region of the region 906, a status to be displayed in relation to the copying function is displayed, and in a region below the upper region, a copy ratio, a paper feeding stage to be selected, and the number of copies to make are displayed.

In addition, for the touch keys for setting an operation mode of the copying function, a Direct key, a Copy Ratio key, a Paper Select key, a Finisher key, a Two-Sided key, an Interrupt key, a Text key, a left arrow key corresponding to a “Thinning” function for density adjustment, a right arrow key corresponding to a “Thickening” function for density adjustment, and an “Auto” key for automatically adjusting the density are displayed on the screen. In addition, a screen for instructing the operation modes that cannot be displayed in the initial screen is displayed hierarchically in the region 906 by pushing down an Advanced Mode key.

In addition, a display region 907 is a region for displaying the status of the copying machine 1001. More specifically, the display region 907 is a region for displaying an alarm message indicating jamming and the like and a status message indicating that PDL printing is being carried out when the PDL printing is currently carried out, for example. In the display region 907, a System Monitor/Suspend touch key 908 is displayed. When the System Monitor/Suspend touch key 908 is pushed down, a screen displaying the device information of the copying machine 1001 and a screen displaying a print job status (not shown) are displayed. In this screen, an operation can be performed to suspend a job.

When the Send/FAX tab 902 is pushed down, a setting screen (not shown) for sending an image read by the copying machine 101 to a device on the LAN 106 by e-mail or FTP and sending a facsimile by using the PSTN 1008 is displayed.

When the Box tab 903 is pushed down, a setting screen (not shown) for storing an image read by the copying machine 101 into the box area in the HDD 2004, specifying image data stored in the box area for printing, and sending the image data to a device on the LAN 1006 is displayed.

When the Browser tab 904 is pushed down, the browser activation screen as shown in FIG. 6 opens. In the browser function as described below, web content indicated by a specified URL is obtained and displayed. The web content in this case includes information described in HTML format or XML format and the like, and is obtained by using a protocol such as HTTP and the like.

In FIG. 6, a URL entry field 911 is pushed down in opening a web page by specifying a URL. BY pressing down the URL entry field 911, a software keyboard (a QWERTY type keyboard) is displayed, and the user can specify a URL by using the software keyboard. By using a Favorites key 912, URLs can be registered, rearranged, and displayed. A display region 913 is a region in which content obtained in accordance with the specified URL is displayed.

A Back key 914 is a key for returning the content displayed in the display region 913 to a content previously displayed. A Forward key 915 is a key for forwarding the content displayed in the display region 913 after the content is once returned to the content previously displayed. A Reload key 916 is a key for displaying a currently displayed page by reloading (by again obtaining the page based on the specified URL). A Stop key 917 is a key for stopping reading a page. A Home key 918 is a key for shifting to a page of a web site that is currently set.

A Print key 919 is a key for printing a page that is currently displayed. By pressing this key, a print setting dialog (not shown) is displayed. In the print setting dialog, a screen for a setting as to how a frame is printed or a setting related to printing (number of copies to be printed, whether the printing is performed two-sided or one-sided, sorting, and the like) is displayed. By pressing down a print start key within the screen, printing starts. A Menu key 920 is a key for displaying a screen for a change in a display ratio of the screen, a change in the size of characters, a change in character codes, and the like.

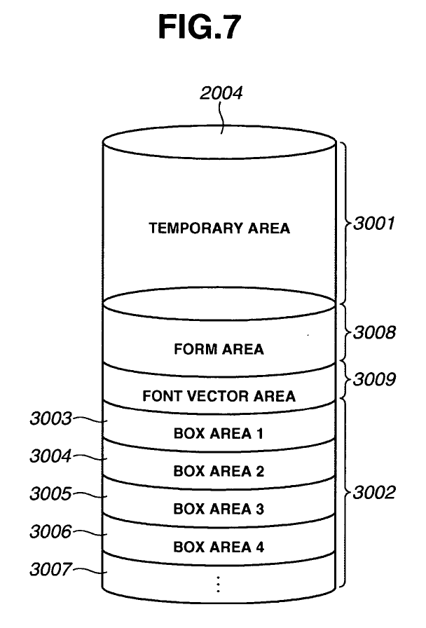

FIG. 7 is a diagram illustrating an exemplary method for logically using the HDD 2004 shown in FIG. 2. In this embodiment, storage areas of the hard disk other than a form area 3008 (in which form data that is previously prepared is stored) and a font vector area 3009 (in which font data in a vector format is stored) that the user cannot use are segmented into a temporary area 3001 and a box area 3002.

Note that the temporary area 3001 is a storage area for temporarily storing rasterized data of PDL data or image data obtained from the scanner, which is provided so that an output can be performed by a single scanning in the case of a plural-copy output. Further, the temporary area 3001 is also used for storing a secure print job.

In addition, the box area 3002 is a storage area for using the box function. The box area 3002 is divided and segmented into a plurality of storage areas such as boxes 3003 through 3007. A box name and a password can be added to each of the boxes 3003 through 3007 in accordance with a specification by the user. The user can input a PDL job or a scan job to a desired box by specifying the box. The user, entering a password, can actually browse images stored in the box, perform a change in the setting of an image, and print out an image.

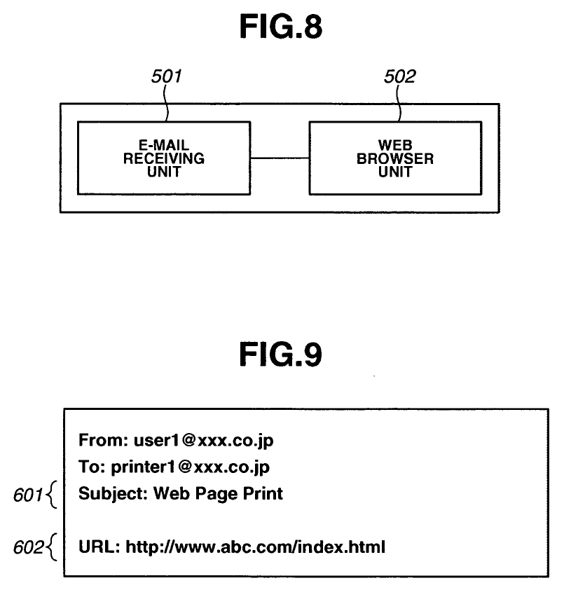

FIG. 8 is a diagram illustrating an exemplary configuration of application software that is executed by the CPU 2001 shown in FIG. 2 according to the present embodiment. Here, an e-mail receiving unit 501 receives an e-mail sent to the copying machine 1001, as described later below, analyses the content of the e-mail, and performs various kinds of processings in accordance with a result of the analysis. Note that various kinds of setting values required for operating the e-mail receiving unit 501, for example, information such as an address of an e-mail server, an interval of confirmation of receiving of the e-mail, and the like, are previously set by an administrator, and the set values are stored in the HDD 2004. A web browser unit 502 is provided with a function for performing a communication (to be described later below) with the e-mail receiving unit 501, as well as a function for displaying the content included in the page indicated by the above-described URL specified and input by the user.

The user sends a print instruction mail as shown in FIG. 9 with the copying machine 1001 as a destination from a computer terminal device (not shown) such as the client computer 1005 and a cellular phone having an e-mail function. The print instruction mail is stored in the database/mail server 1004.

FIG. 9 is a diagram illustrating an example of an e-mail that is sent from the client computer 1005 shown n FIG. 1 to the copying machine 1001. In the example shown in FIG. 9, the e-mail is, for example, is a print instruction mail, and a URL is set as an obtaining destination of a content to be printed. In the example shown in FIG. 9, the mail address of a user is “user1@xxx.co.jp”, and the mail address of a print destination (the copying machine 1001) is “printer1@xxx.co.jp”.

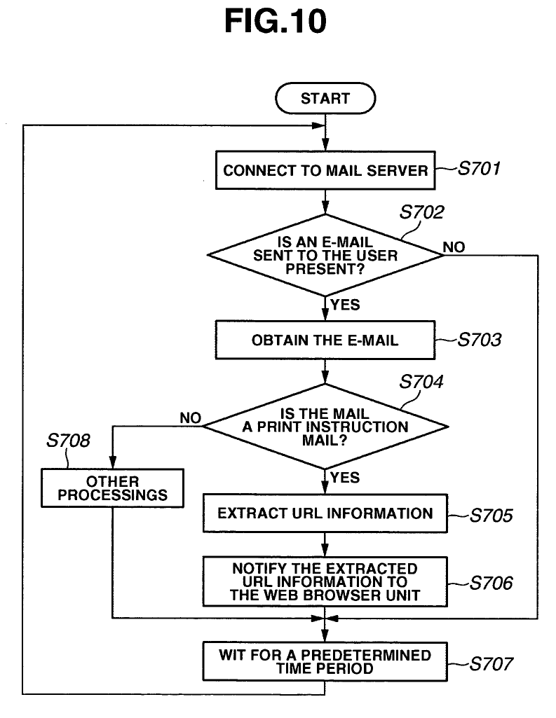

Hereinbelow, processing performed by using the e-mail receiving unit 501 shown in FIG. 8 is described with reference to a flow chart shown in FIG. 10.

FIG. 10 is a flow chart illustrating an example of a first data processing procedure performed by the copying machine 1001. First, in step S701, the network interface 2010 of the copying machine 1001 connects to the database/mail server 1004 shown in FIG. 1 via the LAN 1006. In step S702, the network I/F 2010 confirms whether there is a mail sent to the copying machine 1001. The procedure for confirmation in this case is in conformity to a publicly known Post Office Protocol (POP). If it is determined that there is no mail sent to the copying machine 1001, processing advances to step S707 and waits for a predetermined time period (the interval of confirmation to a mail server (POP server) that is previously set to the copying machine 1001), and then processing returns to step S701.

On the other hand, if it is determined that there is a mail sent to the copying machine 1001, the mail sent to the copying machine 1001 is received (obtained) in step S703. Then, in step S704, it is determined whether the received mail is a print instruction mail of a data format such as that shown in FIG. 9.

Note that in this embodiment, the received mail is determined in step S704 to be a print instruction mail when the subject 601 of the header portion, for example, is determined to be a previously-set character string (in the example of FIG. 6, “web page print”). However, the determination method is not limited to the above-described method. That is, various kinds of methods for determination such as describing information indicating that the mail sent to the copying machine 1001 is a print instruction mail in the body of the mail can be employed.

Then, if in step S704 it is determined that the received mail is a print instruction mal, processing advances to step S705. In step S705, URL information included in the body of the mail is extracted by a predetermined data processing. After that, in step S706, the extracted URL formation is notified to web browser unit 502. The URL information is access information for allowing the web browser unit 502 to obtain the content of a web site on the LAN 1006 by accessing the web site. The URL information includes a domain name such as the URL 602 described in the mail as shown in FIG. 9. However, the URL information can be information that directly specifies an IP address.

Next, in step S707, processing waits for a predetermined period of time, and then returns to step S701. On the other hand, if the received mail is determined not to be a print instruction mail as a result of the determination in step S704, processing advances to step S708, and then various other processings are performed. After that, processing advances to step S707. Note that other processings performed in step S708 include, for example, processing for printing the body of the mail. In this case, if the URL information is included in the received mail, the content of a page indicated by the URL is not obtained because the URL information is a part of the body of the mail, and only the body part of the mail is printed.

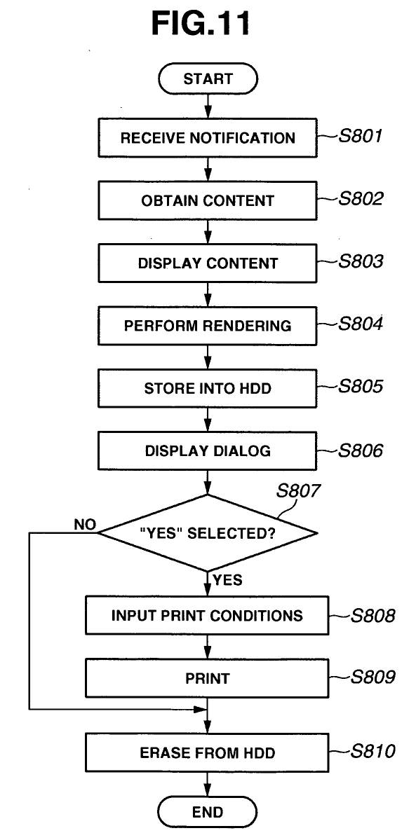

Next, operation of the web browser unit 502 when the notification of the URL information is received from the e-mail receiving unit 501 is described below with reference to the flow chart of FIG. 11.

FIG. 11 is a flow chart illustrating an example of a second data processing performed by the copying machine 1001. This flow chart corresponds to the data processing procedure taken by the web browser 502 shown n FIG. 8 (the processing procedure taken when the notification of the URL information is received from the e-mail receiving unit 501 in step S706).

First, in step S801, when the notification of the URL information is received from the e-mail receiving unit 501, in step S802, the content corresponding to the notified URL information is obtained in accordance with the protocol (HTTP and the like) specified by the URL. Then, in step S803, the obtained content is displayed in the display region 913 within the browser activation screen shown in FIG. 6. Note that the content to be obtained is not limited to a still image and can be moving image data. More specifically, the content to be obtained may be content that can be processed into data that can be printed by a publicly known electronic still image forming processing and the like. In addition, the content to be obtained may be of any kind of data that can be displayed by the web browser unit 502 (or any kind of data that can be printed by the printer 2095 even if the data cannot be displayed by the web browser unit 502) such as a PDF file except a web page of the HTML format. That is, various kinds of printable resource on the network can be utilized for the content to be obtained.

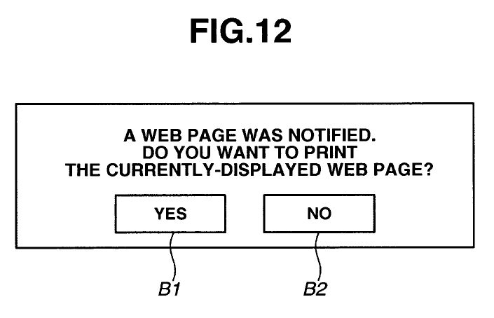

After that, in step S804, data of the obtained content is analyzed by a rendering engine to rasterize the data into printable bitmap data. Then, in step S805, the bitmap data is stored in the temporary area 3001 of the HDD 2004. Then, in step S806, a dialog shown in FIG. 12 is displayed in the LCD display unit 2013 to allow the user to input an instruction as to whether the content is to be printed.

FIG. 12 is a diagram illustrating an example of a dialog displayed in the LCD display unit 2013 of the operation unit 2012 shown in FIG. 4. The dialog shown FIG. 12 is displayed to allow the user to confirm whether the printing of the web page obtained in step S802 is to be executed or not.

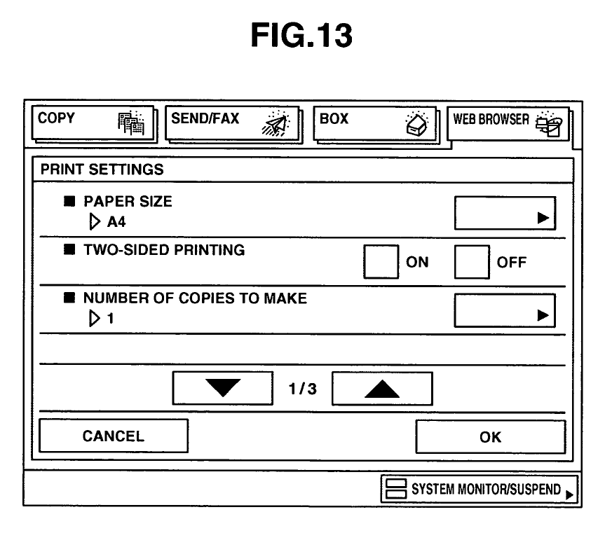

Now referring back to FIG. 11, in step S807, if it is determined that the user has selected a Yes button B1 in the displayed screen shown in FIG. 12, processing advances to step S808. In step S808, the user is prompted to input a print condition through a screen of the format shown in FIG. 13 (in this embodiment, the screen format conforming to the display screen shown in FIG. 5). Then, when an OK button is pressed, the printing is executed in step S809, and then in step S810, the bitmap data stored in the HDD 2004 is erased. Then, processing ends. Note that the printing in this case is performed after a processing for arranging the format of the obtained web page to be of a size corresponding to the specified paper size is performed.

FIG. 13 is a diagram illustrating an example of a print setting screen for allowing the user to perform an operation therethrough, which is displayed in the LCD display unit 2013 of the operation unit 2012 shown in FIG. 4. In this embodiment, for example, buttons such as a Paper Size button, a Two-Sided button, a Number of Copies button, a Print Cancel button, a Print Start button are disposed in the print setting screen. However, the print setting screen is not limited to this configuration. That is, items that can be set may be added so that other settings including a function for optionally connecting to an engine of the copying machine 1001 can be performed. For example, the items to be added include a collate print setting, a layout print setting (N in 1), a setting as to a color/monochromatic print setting.

Referring back to FIG. 11, on the other hand, if the user selects a No button B2 in step S807, processing advances to step S810. In step S810, the rasterized bitmap data is erased without performing printing.

Thus, the connection to a URL specified by utilizing a network environment of the copying machine 1001 is established to obtain and print desired content, based on an instruction by an e-mail sent from e-mail software for a common and general personal computer or a portable device. Accordingly, an instruction for obtaining content and a print instruction can be freely made without providing and installing another interface unit to the copying machine 1001.

### Second Exemplary Embodiment

In the first embodiment, an explanation has been made as to a case where a URL is specified and a print instruction is performed from a portable device and the like by e-mail and a print condition is set through a setting screen shown in FIG. 13 via the operation unit 2012 when the copying machine 1001 receives the e-mail. In the second embodiment, the e-mail sent from the portable device to the copying machine 1001 includes print setting as well as a content obtaining destination shown in FIG. 9. Thereby, a burden of performing the print setting on the user by the copying machine 1001 is alleviated, and thus a convenience for the user increases. Hereinbelow, an explanation is made as to the second embodiment, which has such configuration. Note that the network configuration, the system configuration, the hardware configuration, and the software configuration are similar to those of the first embodiment, except where especially noted and explained.

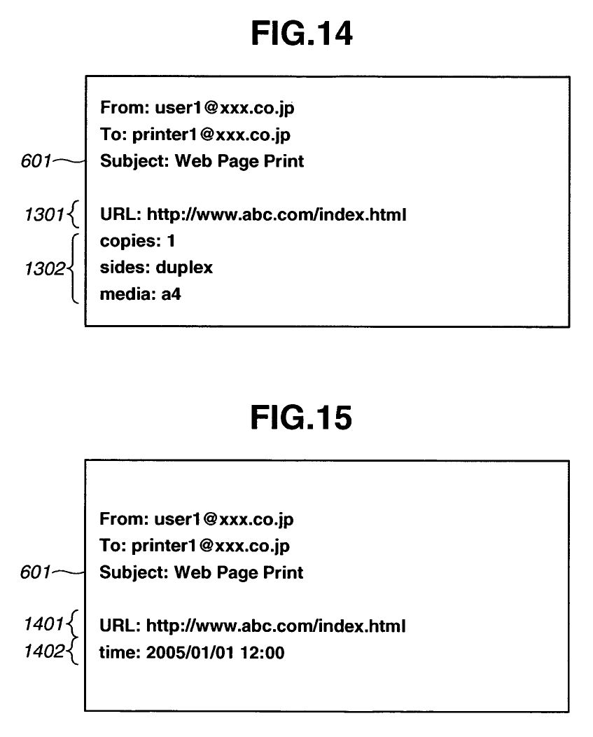

FIG. 14 is a diagram illustrating an example of the print instruction mail that can be set from a portable device in the second embodiment of the present invention. The portions of the configuration of the second embodiment that are similar to those shown in FIG. 9 are denoted by the same reference numerals. In the second embodiment, the user sends the print instruction mail as shown in FIG. 14 to the copying machine 1001.

In FIG. 14, in the second embodiment, a print condition 1302 is described in the e-mail, in addition to a URL 1301 of the content described in the first embodiment. Note that the print condition 1302 represents a condition in which the setting as to the number of prints to make, the specification as to one-sided/two-sided printing, the paper size, and the like can be set. However, the items that can be set are not limited to these. In this regard, FIG. 14 shows an example in which the number of copies to make is 1, the two-sided printing is specified, and the paper size is A4 size.

In addition, the data processing procedure is similar to the procedure shown in FIG. 10 in which the e-mail receiving unit 501 as described in the first embodiment performs. In the second embodiment, the print condition is extracted in addition to the URL information in step S705 (from FIG. 10), and in step S706, the URL information and the print condition are notified to the web browser unit 502. Note that the copying machine 1001, when the print condition is extracted, if the print condition includes a condition that cannot be set to the copying machine 1001, automatically modifies the non-settable condition to a condition that can be set and performs the printing under such print conditions. Alternatively, the data processing procedure can be arranged such that the mail address of a requesting source is extracted from the received e-mail, then a inquiry/request mail (a mail for requesting a modification of the print condition due to the presence of the setting that cannot be performed) is sent to the requesting source, and the setting is modified and appropriately set again based on a mail sent in reply to the inquiry/request mail.

In addition, a difference point from the first embodiment is that with regard to the operation by the web browser unit 502, step S808 described in the flow chart of FIG. 11 is unnecessary in the second embodiment because the print condition 1302 is notified from the e-mail receiving unit 501 and that the printing is performed under the print condition notified from the e-mail receiving unit 501. However, the configuration of the embodiment can be arranged such that if the print condition that cannot be performed by the copying machine 1001 is included, a message indicating that the setting that cannot be performed by the copying machine 1001 is included is displayed when displaying the dialog shown in FIG. 12, thus prompting the user to perform and modify the setting again through the screen shown in FIG. 13.

Alternatively, the configuration of the second embodiment can be arranged such that printing may be automatically performed in accordance with the print setting previously set as a default setting to the copying machine 1001, instead of performing the print setting by the e-mail or performing the print setting through the copying machine 1001 after the content is obtained. Note that in this case, the processing of steps S806 through S808 (from FIG. 11) is not performed.

Thus, the user does not need to perform the operation of performing the print setting through the copying machine 1001 after sending the e-mail, and thereby the convenience for the user improves.

### Third Exemplary Embodiment

In a third embodiment of the present invention, the user can specify, by an e-mail, a URL and a print start time of content corresponding to the specified URL.

FIG. 15 is a diagram illustrating an example of the print instruction mail that can be set from a portable device and the like according to the third embodiment. The portions that are similar to those shown in FIG. 9 are denoted by the same reference numerals.

In the third embodiment, printing of the obtained content can be started at a specified time because time information is described in the print instruction mail, in addition to the URL information.

In FIG. 15, the user sends the print instruction mail to the copying machine 1001 as the sending destination. In the third embodiment, time information 1402 can be described in the print instruction mail in addition to the URL 1401 of the content. The flow chart in relation to the operation by the e-mail receiving unit 501 is similar to the flow chart shown in FIG. 10. However, in step S705 (from FIG. 10), the time information is extracted from the body of the mail as the URL information, as well as the URL itself, and the URL information is notified to the web browser unit 502 in step S706.

On the other hand, as to the operation by the web browser unit 502, the processing, when the notification of the URL information is received from the e-mail receiving unit 501 in step S801 (from FIG. 11), waits until the notified time comes, and after that, performs the processing of step S802 and subsequent steps.

Thus, printing can be automatically performed at the time specified by the user to obtain content, with a simple configuration such that the user sets the print start time that the user desires by description in the print instruction mail. Note that the configuration can be arranged such that the content is obtained at the time of receiving the e-mail, instead of obtaining the content at the specified time. Then, the obtained content is stored in the HDD 2004, and the stored content is read and printed when the specified time comes.

### Fourth Exemplary Embodiment

In a fourth embodiment of the present invention, the content obtained from the URL included and described in the received e-mail is not printed at the time of obtaining the content and is stored in any one of a plurality of box areas provided in the HDD 2004, and the user prints out and browses the stored content at a timing that the user desires.

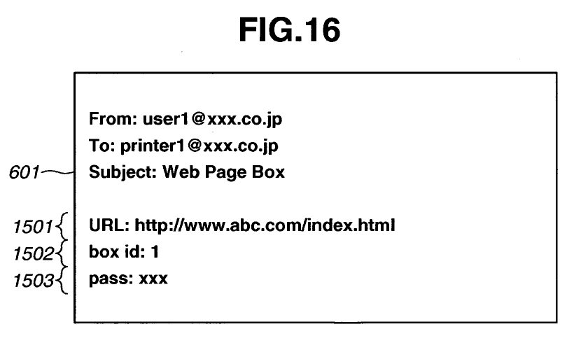

FIG. 16 is a diagram illustrating an example of a storage instruction mail that can be set through a portable device in the fourth embodiment. The portions that are similar to those of FIG. 9 are denoted by the same reference numerals.

In FIG. 16, the user sends to the copying machine 1001 the storage instruction mail for storing content into the box. In the fourth embodiment, when a Subject 601 of the mail is set to be “Web Page Box”, the e-mail receiving unit 501 determines that the received mail is a storage instruction mail. The storage instruction mail can include, in addition to a URL 1501 of the content, a box ID 1502 and a password 1503 in relation to a box area provided in the HDD 2004 as shown in FIG. 7.

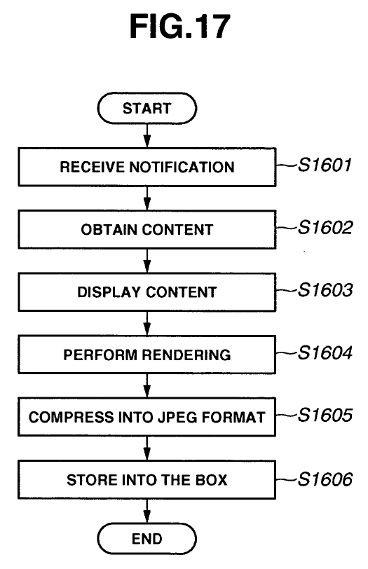

The flow chart of the operation by the e-mail receiving unit 501 is substantially similar to the flow chart of FIG. 10. However, in step S704, as described above, a determination is made as to whether the received mail is a storage instruction mail. In addition, in step S705, the URL and the box ID/password of the received mail are extracted from the body of the mail, and the extracted URL and the box ID/password are notified to the web browser unit 502 in step S706. The operation of the web browser unit 502 is described below with reference to the flow chart of FIG. 17.

FIG. 17 is a flow chart illustrating an example of the second data processing procedure performed by the copying machine 1001 according to the fourth embodiment. This example corresponds to the data processing procedure performed by the web browser unit 502 shown in FIG. 8 (the processing procedure performed by the web browser unit 502 when the web browser unit 502 receives from the e-mail receiving unit 501 the notification of the URL and the box ID/password).

First, when the web browser unit 502 receives from the e-mail receiving unit 501 the notification of the URL and the box ID/password in step S1601, the web browser unit 502 obtains the content of the notified URL in step S1602 and displays the obtained content in step S1603.

Then, in step S1604, the web browser unit 502 analyzes data of the obtained content by using a rendering engine. Then, the analyzed content data is rasterized into printable bitmap data and is then written into an image memory. After that, in step S1605, the printable bitmap data is compressed in a compression format such as JPEG by the image compression unit 2040. Then, in step S1606, the compressed image data is stored in either one of the box areas 3003 trough 3007 specified by the box ID 1502 of the storage instruction mail as shown in FIG. 16. Then, processing ends. The image data stored in the box is decompressed by entering the box ID and the password in accordance with the instruction from the operation unit 2012, the client computer 1005, and the like. Thus, the image data can be browsed through the operation unit 2012 or the client computer 1005, and can also be printed by the printer 2095.

Thus, the image data can be stored in either one of the box areas provided in the HDD 2004 without printing the obtained content, with a simple configuration such that the storage instruction mail for storing into the box is sent as an e-mail from a portable device and the like.

### Fifth Exemplary Embodiment

In a fifth embodiment of the present invention, when the user specifies a URL, a user ID, and a password utilizing an e-mail, the copying machine 1001 obtains content of the pages indicated by the URL, and the copying machine 1001 stands by for printing of the obtained content in a state in which the obtained content can be printed. Then, when the user ID and the password are entered via the operation unit 2012, the print operation by the printer 2095 starts. A point in difference from the fourth embodiment is that the print operation can be started in a shorter period of wait time by causing the copying machine 1001 to wait in a state where the print operation by the printer 2095 can be started immediately and by allowing the user to perform the operation through the operation unit 2012, compared with the case where the content to be printed is stored in the box. This configuration is intended to store and maintain the data in a format by which the printing by the printer 2095 can be performed at a high speed. That is, a compression ratio of the content to be printed according to the fifth embodiment is not high while the compression ratio of the content to be printed according to the fourth embodiment is prioritized.

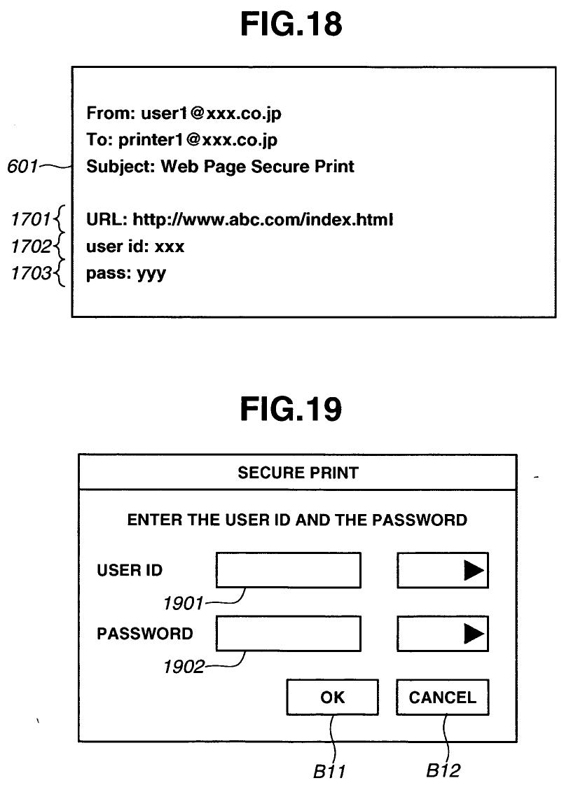

FIG. 18 is a diagram illustrating an example of a print instruction mail that can be set from a portable device and the like according to the fifth embodiment. In the fifth embodiment, the portions that are similar to those shown in FIG. 9 are denoted by the same reference numerals.

In FIG. 18, the user sends to the copying machine 1001 a secure print instruction mail. In the fifth embodiment, when the Subject 601 of the mail is set to be “Web Page Secure Print”, the e-mail receiving unit 501 determines that the received mail is a secure print instruction mail. In addition, the secure print instruction mail includes, in addition to a URL 1701 of the content, a user ID 1702 and a password 1703.

The flow chart of the operation by the e-mail receiving unit 501 is substantially similar to the flow chart of FIG. 10. However, in step S704 (from FIG. 10), as described above, a determination is made as to whether the received mail is a secure print instruction mail. In addition, in step S705, the URL and the user ID/password of the received mail are extracted from the body of the mail, and the extracted URL and the box ID/password are notified to the web browser unit 502 in step S706.

In the operation of the web browser unit 502, a dialog shown in FIG. 19 is displayed by the LCD display unit 2013 of the operation unit 2012 before printing is performed in step S809 of the flow chart of FIG. 11. The printing operation is performed only when the user enters a correct and appropriate user ID/password.

FIG. 19 is a diagram illustrating an example of a dialog displayed on the secure print instruction screen of the copying machine 1001 according to the fifth embodiment. The dialog is displayed on the LCD display unit 2013 of the operation unit 2012 under the control of the CPU 2001.

In FIG. 19, reference numeral 1901 denotes a user ID field. When the user enters the user ID that is allotted to the user in advance by operating keys of the operation unit 2012, the content of the user ID is displayed on the user ID field. Reference numeral 1902 denotes a password field. In the password field 1902, when the user enters the password that is allotted to the user by operating keys of the operation unit 2012, the content of the password is displayed in masked characters such as, for example, “***”. An OK button B11 serves to issue an authentication instruction and a print instruction. A Cancel button B12 can be pressed so as to cancel the secure printing.

Thus, the secure print processing of the content that is temporarily stored can freely be performed by performing the setting as to an instruction for obtaining the content and a secure print instruction at the same time, with the simple configuration in which the secure print instruction mail is sent as an e-mail from a portable device or the like.

According to the aforementioned embodiment, an image processing apparatus in which a print instruction for printing web content, an instruction for storing web content, and the like can readily be issued through a computer on the network can be provided. In addition, in such printing operations, content data is previously obtained and is subjected to a rendering operation, so that wait time for printing can be shortened.

### Sixth Exemplary Embodiment

In the above-described embodiments, an explanation has been made as to the case where printing of the whole content is performed by the printer 2095 of the copying machine 1001. However, the configuration can be arranged such that attributes of the content to be output, such as “image only”, “text only”, “graphics only”, and “only specified page in plural pages”, are specified by an e-mail and the extracted content is selectively printed.

Further, the configuration can be arranged such that when the number of prints to make is large, an e-mail addressed to a plurality of output destinations is sent so that prints are output in a distributed manner from other image processing apparatus, and thus an instruction for outputting the content to the output destinations can be issued.

Further, a plurality of sources for obtaining content may be set at the same time, that is, the source for obtaining the content is not limited to one. Further, except when the setting as to the character size and the typeface of the content is based on a default setting of the copying machine 1001 in a case where the content includes a text, the character size and the typeface can be set by an e-mail. In addition, the content obtained by the above method can further be set by an e-mail so that the content is sent to a specified facsimile or to other devices via the network.

In addition, the configuration can be arranged such that information that specifies the user is included in an e-mail sent from a portable device and the like to the copying machine 1001, the copying machine 1001 stores different settings as to each user information or each address indicated in a “From:” field of the e-mail, and the processing in accordance therewith is performed.

That is, the setting is performed in such a manner that the print settings for obtaining content are different from each other for each different user, that the content obtained in relation to each user is automatically printed or stored in the memory without printing the content, and then, in addition, if the content is to be stored, the setting as to where the content is to be stored in a plurality of memory boxes is performed. In addition, the setting can be performed such that a specified user only can obtain the content, or that a specified user can obtain and display the content but cannot print the content.

In addition, in authenticating the user in this way, a password can preferably be included in an e-mail. Further, if the user can describe a specific keyword, in addition to the user information, different settings can be performed per each keyword, and thus, various kinds of processing settings can be performed.

In addition, a plurality of different mail addresses for receiving an e-mail can be set to the copying machine 1001, and different processings may be allotted for each different mail address. In this case, the processing for the content of the URL included in the e-mail is different in accordance with the address of the received e-mail.

Further, in processing content on the web, there is a web site that provides the content, while using a cookie that includes user information, in accordance the content of the cookie. In order to correspond to this kind of web site, the configuration can be arranged such that the copying machine 1001 stores the cookie for each user, that the user is specified based on the received e-mail, and that the content in a form corresponding to the specified user is obtained by sending and receiving the cookie in accessing the URL described in the e-mail.

In addition, there is a case where when the user sends an e-mail using a portable device and the like, the portable device is distant from the copying machine 1001. Therefore, when the copying machine 1001 completely obtains the content or when the printing starts or ends, the user can be notified to that effect by a response of the e-mail. In this case, if any error occurs in relation to the copying machine 1001, an e-mail as to that effect may be notified to the user.

According to the above-described embodiment, content desired by the user can be obtained and processed, under an environment in which the copying machine is connected to the network, by receiving a request for obtaining the content from a portable device or an external device such as a client computer and a request for processing the content by an e-mail at the same time. Thus, the above processing can be provided by using a general purpose e-mail, without using dedicated application software. In addition, the user does not need to perform a complicated operation through the operation unit of the copying machine.

Note that in the above-described embodiment, a digital copying machine equipped with a plurality of functions is discussed as an example. However, the configuration of the embodiments is not limited to that. That is, a digital copying machine can at least be provided with an e-mail receiving function and a function for extracting a URL from the received e-mail, obtaining web content according to the URL, and performing processing therefor.

Further, the configuration of the present embodiment can be arranged such that an instruction for performing processing can be received by a method other than an e-mail, and the content obtained based on the received instruction can be applied to the content that is specified by access information other than a URL.

### Other Exemplary Embodiments, Features and Aspects of the Present Invention

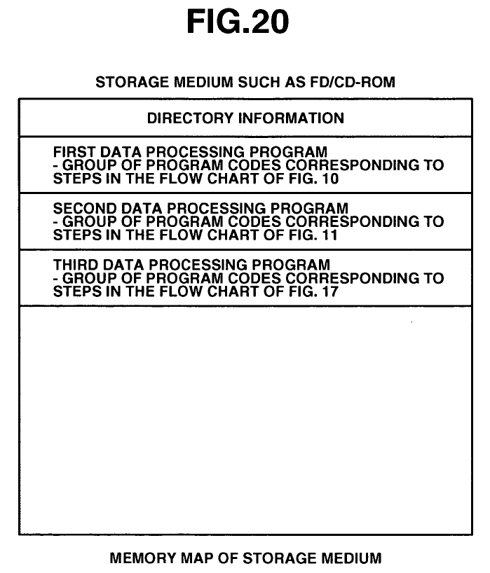

A configuration of a data processing program that can be read by the copying machine of the embodiments is described below with reference to a memory map shown in FIG. 20.

FIG. 20 is a diagram illustrating a memory map of a storage medium in which various kinds of data processing programs that can be read by the copying machine of the embodiments are stored.

Note that information for managing a group of programs that can be stored in the storage medium, for example, version information and information on a program designer, are stored, and in addition, information that depends on an OS (operating system) and the like of the program reading device, for example, icons and the like for identifying and displaying the programs, can be stored therein in some cases.

Further, data that is subordinate to various kinds of programs is stored in the above directory. In addition, if a program for installing various kinds of programs to the computer or a program to be installed to the computer are compressed, programs and the like for decompressing the compressed program can be stored in some cases.

The functions shown in FIGS. 10, 11, and 17 in the above-described embodiments can be performed by a host computer according to a program that is externally installed. In addition, in this case, the present invention can be applied in a case where a group of information that includes programs is supplied by a storage medium such as a CD-ROM, a flash memory, a floppy disk, and the like or from an external storage medium via the network, to an outputting apparatus.

The aspect of the present invention can also be achieved by providing a system or an apparatus with a storage medium which records program code of software implementing the functions of the embodiments and by reading and executing the program code stored in the storage medium with a computer (CPU or MPU) of the system or apparatus.

In this case, the program code itself, which is read from the storage medium, implements the functions of the embodiments described above, and accordingly, the storage medium storing the program code constitutes the present invention.

Therefore, if the program is provided with a function of program, the form of the program can take any form such as object code, a program that is executed by an interpreter, script data to be supplied to the OS, and the like.

The storage medium for supplying such program code includes, for example, a floppy disk, a hard disk, an optical disk, a magneto-optical disk, a CD-ROM, a CD-R, a magnetic tape, a nonvolatile memory card, a ROM, a DVD and the like.

In this case, the program code itself read from the storage medium implements the functions of the embodiments described above, and the storage medium which stores the program code configures the present invention.

The above program can also be supplied by connecting to a web site on the Internet by using a browser of the client computer and by downloading from the web site to a storage medium such as a hard disk and the like the computer program itself or a compressed file including an automatic installation function. In addition, the present invention can be implemented by dividing the program code that constitutes the program of the present invention into plural files and downloading each file from different web pages. That is, a www server and an ftp server for allowing a plurality of users to download the program file for implementing functions and processing in a computer can be included in the aspect of the present invention.

In addition, the above program can also be supplied by distributing a storage medium such as a CD-ROM and the like which stores the program code after encryption thereof, by having a user who is qualified for a prescribed condition download key information for decoding the encryption from the web site via the Internet, and by executing and installing in the computer the encrypted program code by using the key information. In addition, the functions according to the embodiments described above are implemented not only by executing the program code read by the computer, but also implemented by the processing in which an OS (operating system) or the like carries out a part of or the whole of the actual processing on the basis of an instruction given by the program code.

Further, in another aspect of the present embodiment, after the program code read from the storage medium is written in a function expanding board inserted in the computer or a memory which is provided in a function expanding unit connected to the computer, a CPU and the like provided in the function expanding board or the function expanding unit carries out a part of or the whole of processing to implement the functions of the embodiment described above.

It is noted that the present embodiments of the present invention can be executed at the same time if each of the embodiments can be combined to each other.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-143722 filed May 17, which is hereby incorporated by reference herein in its entirety.

What is claimed is:

1. A data processing apparatus comprising:
a receiving unit configured to receive an electronic mail including access information for accessing resource from a network;
an extracting unit configured to extract the access information from the received electronic mail;
an obtaining unit configured to obtain resource from the network based on the extracted access information; and
a processor configured to process the obtained resource in accordance with a predetermined procedure.

2. The apparatus according to claim 1, further comprising a printer adapted to print an image, wherein the processor supplies the obtained resource to the printer and causes the printer to print an image based on the resource.

3. The apparatus according to claim 2, wherein the receiving unit receives the electronic mail including the access information and a printing parameter, and wherein the printer prints the image based on the printing parameter.

4. The apparatus according to claim 2, wherein the receiving unit receives the electronic mail including the access information and password for instructing the printer to start the printing, and wherein the printer starts printing in response to entering the password.

5. The apparatus according to claim 1, further comprising a storage unit configured to store the obtained resource, wherein the processor supplies the obtained resource to the storage unit and causes the storage unit to store the resource.

6. The apparatus according to claim 1, wherein the processor changes the processing in accordance with a source of the received electronic mail.

7. The apparatus according to claim 1, wherein the processor changes the processing in accordance with a destination address of the received electronic mail.

8. A control method for a data processing apparatus comprising:
receiving an electronic mail including access information for accessing resource on a network;
extracting the access information from the received electronic mail;
obtaining the resource from the network based on the extracted access information; and
processing the obtained resource in accordance with a predetermined procedure.

9. A computer readable medium containing computer-executable instructions for controlling a data processing apparatus, the medium comprising:
instructions to receive an electronic mail including access information for accessing resource from a network;
instructions to extract the received access information from the received electronic mail;
instructions to obtain the resource from the network based on the extracted access information; and
instructions to process the obtained resource in accordance with a predetermined procedure.
